(19) United States
(12) Patent Application Publication
(10) Pub. No.: US 2025/0181773 A1
(43) Pub. Date: Jun. 5, 2025

(54) IN-VEHICLE SYSTEM, ELECTRONIC CONTROL DEVICE, ACCESS AUTHORIZATION POLICY UPDATE METHOD, AND STORAGE MEDIUM STORING PROGRAM

(71) Applicant: DENSO CORPORATION, Kariya-city (JP)

(72) Inventor: Hideyuki HONYA, Kariya-city (JP)

(21) Appl. No.: 19/006,156

(22) Filed: Dec. 30, 2024

Related U.S. Application Data
(63) Continuation of application No. PCT/JP2023/021939, filed on Jun. 13, 2023.

(30) Foreign Application Priority Data
Jul. 8, 2022 (JP) 2022-110649

(51) Int. Cl. G06F 21/62

(52) U.S. Cl. CPC G06F 21/629

(57) ABSTRACT

An in-vehicle system includes function blocks, each mounted on one of electronic control units connected to an in-vehicle network, or on an external device, each configured to execute a predetermined process; and a coordination control unit implementing coordination between the plurality of function blocks. The coordination control unit is configured to, upon receiving an access request from a use source block to a use destination block, determine whether the use source block has access right to the use destination block using an access authorization policy, and to transmit the access request to the use destination block; determine whether to be in an update necessity state where there is a need to implement an update to the access authorization policy; determine whether a state of the vehicle equipped with the in-vehicle network is in a safe state; and implement the update to the access authorization policy.

### CROSS REFERENCE TO RELATED APPLICATIONS

The present application is a continuation application of International Patent Application No. PCT/JP2023/021939 filed on Jun. 13, 2023 which designated the U.S. and claims the benefit of priority from Japanese Patent Application No. 2022-110649 filed on Jul. 8, 2022. The entire disclosures of all of the above applications are incorporated herein by reference.

### TECHNICAL FIELD

The present disclosure relates to a technology for controlling access to resources and information held by a vehicle.

### BACKGROUND

A related art describes a technology, in an open platform for mobile terminals, that uses an access authorization policy to restrict access when access to resources or information held by the system via a service application is detected. The access authorization policy specifies who is permitted or prohibited to do what to what.

### SUMMARY

An in-vehicle system includes function blocks, each mounted on one of electronic control units connected to an in-vehicle network, or on an external device, each configured to execute a predetermined process; and a coordination control unit implementing coordination between the plurality of function blocks. The coordination control unit is configured to, upon receiving an access request from a use source block to a use destination block, determine whether the use source block has access right to the use destination block using an access authorization policy, and to transmit the access request to the use destination block; determine whether to be in an update necessity state where there is a need to implement an update to the access authorization policy; determine whether a state of the vehicle equipped with the in-vehicle network is in a safe state; and implement the update to the access authorization policy.

### BRIEF DESCRIPTION OF THE DRAWINGS

FIG. 1 is a block diagram illustrating a configuration of a mobility service provision system.

FIG. 2 is a block diagram illustrating a configuration of a platform.

FIG. 3 is an explanatory diagram illustrating an outline of an access authorization policy.

FIG. 4 is a flowchart of an access restriction process executed by an access control unit.

FIG. 5 is a flowchart of a policy update process executed by a policy update unit.

FIG. 6 is a flowchart of an update process during parking.

FIG. 7 is a flowchart of an update process during stop.

### DETAILED DESCRIPTION

The inventors of this application have found the followings. In the future, it is expected that an unspecified number of third-party service applications will be installed in electronic control systems installed in vehicles (hereinafter referred to as “in-vehicle systems”). Therefore, it is conceivable to restrict access from these unspecified service applications using an access authorization policy. The access authorization policy is set according to the reliability of the service application that is the source of the access request and the characteristics of the resources or information that is the destination of the access. Furthermore, to meet various needs, it is anticipated that the frequency of updates to the access authorization policy will increase as service applications are frequently added, changed, or deleted.

When the access authorization policy in the in-vehicle system is updated, the criteria for permitting or prohibiting access will change before and after the update. Therefore, depending on the timing of the update, unexpected operations or non-operations may be induced.

One aspect of the present disclosure provides a technology for safely implementing updates to the access authorization policy.

One aspect of the present disclosure is an in-vehicle system comprising a plurality of function blocks and a coordination control unit. The plurality of function blocks are each mounted on one of a plurality of electronic control units connected to an in-vehicle network, or on an external device remotely connected to the in-vehicle network, and are configured to implement functions assigned to each of them. The coordination control unit is configured to implement coordination between the plurality of function blocks.

The coordination control unit includes an access control unit, a necessity determination unit, a state determination unit, and an update execution unit.

The access control unit receives an access request from a use source block, which is one of the plurality of function blocks, to a use destination block, which is another of the plurality of function blocks. The access control unit determines whether the use source block has access right to the use destination block using an access authorization policy that defines access rights between the function blocks. The access control unit is configured to transmit the access request to the use destination block when it is determined that the access right is present.

The necessity determination unit is configured to determine whether to be in an update necessity state where there is a need to implement an update to the access authorization policy. The state determination unit is configured to determine whether a state of the vehicle equipped with the in-vehicle network is in a safe state where the update to the access authorization policy can be safely implemented. The update execution unit is configured to implement the update to the access authorization policy when the necessity determination unit determines to be in the update necessity state and the state determination unit determines that the vehicle is in the safe state.

According to such a configuration, the update of the access authorization policy can be safely implemented.

One aspect of the present disclosure is an electronic control device mounted in a vehicle. The electronic control device includes an access control unit, a necessity determination unit, a state determination unit, and an update execution unit. In other words, the electronic control device has a configuration excluding the plurality of function blocks from the above in-vehicle system.

According to such a configuration, the update of the access authorization policy can be safely implemented.

One aspect of the present disclosure is an access authorization policy update method implemented by an electronic control device mounted in a vehicle. The access authorization policy defines access rights between a plurality of function blocks, each configured to execute a predetermined process.

The access authorization policy update method includes determining whether to be in an update necessity state where there is a need to implement an update to the access authorization policy. The access authorization policy update method includes determining whether a state of the vehicle equipped with the in-vehicle network is in a safe state where the update to the access authorization policy can be safely implemented. The access authorization policy update method includes implementing the update to the access authorization policy when it is determined to be in the update necessity state and it is determined to be in the safe state.

According to such a method, the update of the access authorization policy can be safely implemented.

One aspect of the present disclosure is a program for causing a computer to implement the following functions.

The functions that the program causes the computer to implement include a function to determine whether to be in an update necessity state where there is a need to implement an update to the access authorization policy. The access authorization policy defines access rights between a plurality of function blocks, each configured to execute a predetermined process. The functions that the program causes the computer to implement include a function to determine whether a state of the vehicle is in a safe state where the update to the access authorization policy can be safely implemented. The functions that the program causes the computer to implement include a function to implement the update to the access authorization policy when it is determined to be in the update necessity state and it is determined to be in the safe state.

By executing such a program, the above access authorization policy update method is realized, and as a result, the update of the access authorization policy can be safely implemented.

Hereinafter, an embodiment of the present disclosure will be described with reference to the drawings.

### (1. Configuration)

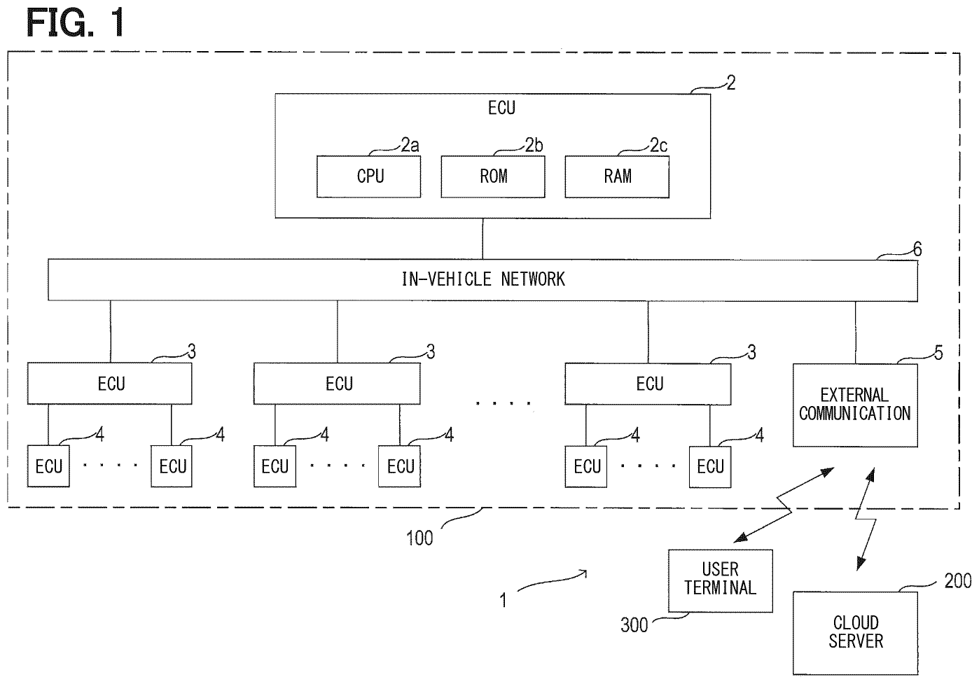

As shown in FIG. 1, a mobility service provision system 1 of the present embodiment includes an in-vehicle system 100 mounted in a vehicle, a cloud server 200, and a user terminal 300. The vehicle may have an automated driving function in addition to a manual driving function. The vehicle may be a hybrid vehicle having an engine and an electric motor as a driving source. The vehicle is not limited to the vehicle having the automated driving function or the hybrid vehicle, but may be a vehicle having only a manual driving function, or a vehicle having only an engine or only an electric motor as the driving source. Hereinafter, the vehicle equipped with the in-vehicle system 100 will be simply referred to as a vehicle.

The in-vehicle system 100 includes one electronic control unit (hereinafter, ECU) 2, multiple ECUs 3, multiple ECUs 4, a vehicle exterior communication device 5, and a vehicle interior communication network 6. The ECU is an abbreviation for Electronic Control Unit.

The ECU 2 controls the plurality of ECUs 3 to achieve coordinated control of the entire vehicle.

The ECU 3 is provided for each domain divided by function in the vehicle, and mainly controls a plurality of ECUs 4 existing within that domain. Each ECU 3 is connected to the ECU 4 under the control thereof via an individually provided lower layer network. The lower layer network is, for example, a Controller Area Network (hereinafter, CAN). The CAN is a registered trademark. The ECU 3 has a function of centrally managing access rights of the ECU 4 under the control thereof and authenticating users. The domain includes, for example, a powertrain, a body, a chassis, a cockpit, and the like.

The ECUs 4 connected to the ECU 3 belonging to the powertrain domain include, for example, an ECU 4 that controls the engine, an ECU 4 that controls the motor, and an ECU 4 that controls the battery.

The ECUs 4 connected to the ECU 3 belonging to the body domain include, for example, an ECU 4 that controls the air conditioner and an ECU 4 that controls the doors.

The ECUs 4 connected to the ECU 3 belonging to the chassis domain include, for example, an ECU that controls the brakes and an ECU that controls the steering.

The ECUs 4 connected to the ECU 3 belonging to the cockpit domain include, for example, an ECU 4 that controls the display of a meter and a navigation device, and an ECU 4 that controls an HMI device 7 operated by a vehicle occupant. The HMI is an abbreviation for Human Machine Interface.

The vehicle exterior communication device 5 performs data communication with a vehicle exterior device such as the cloud server 200 and the user terminal 300 via a wide area wireless communication network.

The vehicle interior communication network 6 includes CAN with Flexible Data Rate (hereinafter, CAN FD) and Ethernet. The Ethernet is a registered trademark. The CAN FD connects ECU 2 to each ECU 3 and the vehicle exterior communication device 5 via a bus. The Ethernet connects ECU 2 and each ECU 3 and the vehicle exterior communication device 5 individually. The ECU 2 may be provided with an Ethernet switch for switching the Ethernet to be used.

The ECU 2 is an electronic control device mainly including a microcomputer including a CPU 2a, a ROM 2b, a RAM 2c, and the like. Various functions of the microcomputer are implemented by the CPU 2a executing a program stored in a non-transitory tangible storage medium. In this example, the ROM 2b corresponds to the non-transitory tangible storage medium that stores a program. Further, by executing this program, a method corresponding to the program is executed. Partial or all of the functions executed by the CPU 2a may be implemented by a hardware circuit, such as one or more ICs. Further, the number of the microcomputers constituting the ECU 2 may be one or more.

The ECU 3, the ECU 4, and the vehicle exterior communication device 5 are all electronic control devices mainly including a microcomputer provided with a CPU, ROM, RAM, and the like, similarly to the ECU 2. Further, the number of the microcomputers constituting the ECU 3 and ECU 4, and the vehicle exterior communication device 5 may be one or more.

Hereinafter, unless otherwise specified, the ECU 2, ECU 3, ECU 4, and the vehicle exterior communication device 5 will be collectively referred to as in-vehicle devices 2 to 5.

### (2. Functional Configuration)

The software installed in the in-vehicle devices 2 to 5 belonging to the in-vehicle system 100 is constructed in accordance with AUTOSAR. The AUTOSAR is an architecture for autonomous driving and is an abbreviation for Automotive Open System Architecture. The AUTOSAR provides not only communication between software components (hereinafter referred to as SW-C) provided to implement various applications, but also functions related to connection to the cloud, security, and the like. The SW-C is parted software to implement a certain function. The application program includes one or more SW-C. The software of the mobility service provision system 1 does not necessarily need to be built along AUTOSAR.

Each of the in-vehicle devices 2 to 5 includes a platform. The platform provides an environment for running SW-C written in a hardware-independent format.

The platform includes a runtime environment (hereinafter, RTE) and base software (hereinafter, BSW). The RTE is the interface between SW-C and between SW-C and BSW. The BSW is the layer connecting hardware and SW-C, including OS, driver, middleware, etc. The functions of the BSW are divided into small modules. The functions of each module are provided to the SW-C via an Application Programming Interface (hereinafter, API).

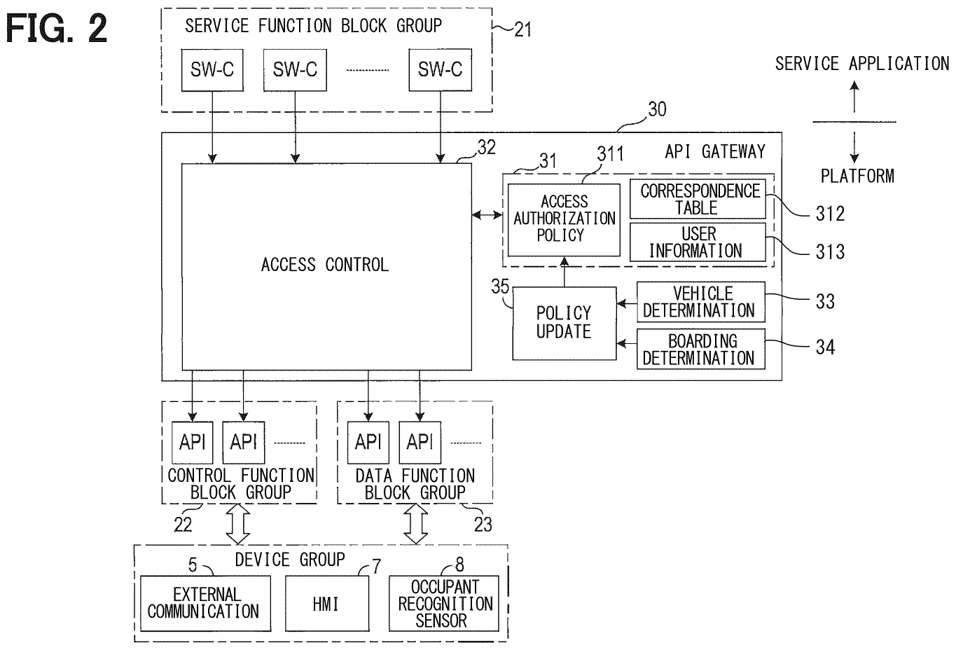

As shown in FIG. 2, the in-vehicle devices 2 to 5 include a service system function block group 21 as a collection of service applications (hereinafter referred to as service applications) operating on the platform. The service application is an application that receives requests from clients, processes them, and returns results. Each service application includes one or more SW-Cs. The service application may be implemented not only in any of the in-vehicle devices 2 to 5, but also in an external device remotely connected to the vehicle interior communication network 6 via the vehicle exterior communication device 5, such as the cloud server 200.

The service system function block group 21 includes service applications (hereinafter, OEM applications) provided by an Original Equipment Manufacturer (hereinafter, OEM). The OEM is the vehicle manufacturer that produced the vehicle. The OEM applications may include applications developed by the OEM itself and applications developed by other vendors. The service system function block group 21 may also include service applications (hereinafter, 3rd applications) provided by third parties. The third party is any party other than the vehicle owner and the OEM. The third party includes, for example, data utilization companies that provide services by collecting data from vehicles.

The platform includes a control system function block group 22, a data system function block group 23, and an API gateway 30.

The control system function block group 22 is a set of service applications equipped with an API for accepting instructions related to the movement of the vehicle and for integrating and controlling the instructions accepted by the API to implement consistent vehicle control. The control system function block group 22 outputs various instructions via the vehicle interior communication network 6 to the in-vehicle devices 3 to 5 in which there is an embodiment that executes control based on the directive. The control system function block group 22 may have a function to convert various instructions (i.e., API access requests) from the service system function block group 21 expressed in a vehicle-independent format into instructions expressed in a vehicle-dependent format.

The data system function block group 23 is a set of service applications equipped with an API for handling vehicle data held by the in-vehicle devices 2 to 5. The data system function block group 23 may have an API that provides a function to abstract and accumulate vehicle data expressed in a vehicle-dependent format supplied from each in-vehicle device 2 to 5 into a vehicle-independent format. The data system function block group 23 may have an API that provides a function to upload the stored vehicle data to the cloud server 200 via the vehicle exterior communication device 5.

In the following, the APIs provided by the service applications belonging to the control system function block group 22 and the data system function block group 23 are referred to as vehicle APIs. The vehicle APIs may include APIs that provide a function to acquire an access authorization policy described later from the cloud server 200 or the like via the vehicle exterior communication device 5. The vehicle APIs may include APIs that provide a function to communicate with the user terminal 300 via the vehicle exterior communication device 5. The vehicle APIs may include APIs that provide a function to provide information to occupants and accept input operations from occupants via the HMI device 7 provided in the vehicle. The vehicle APIs may include APIs that provide a function to acquire information necessary for determining the presence or absence of occupants from an occupant recognition sensor 8 provided in the vehicle. The occupant recognition sensor 8 may be a camera that captures the interior of the vehicle or a pressure sensor that detects the load applied to the seat.

The API gateway 30 is configured by utilizing the functions of the virtual function bus (hereinafter referred to as VFB). The VFB is middleware that enables communication between SW-C and between SW-C and BSW without awareness of hardware or communication protocol, also called software bus. Communication between SW-Cs is performed between service applications belonging to the service system function block group 21, and refers to an access from a SW-C to an API provided by another SW-C. Communication between SW-C and BSW refers to access from SW-C to the vehicle API between service applications belonging to the service system function block group 21 and service applications belonging to the control system function block group 22 and the data system function block group 23. In the following description, it is assumed that the SW-C and the service application correspond one-to-one.

When a service application uses a function provided by the control system function block group 22 and the data system function block group 23, the service application transmits an API access request, which is an access request to the vehicle API. The API access request includes at least the process ID of the service application that is the source of use (hereinafter, use source application) and an API-ID that is information that uniquely identifies the vehicle API that is the destination of use (hereinafter, use destination API).

### (3. Access Restriction Mechanism)

The API gateway 30 is provided in the platform of all in-vehicle devices 2 to 5, which may include any of the service system function block group 21, the control system function block group 22, and the data system function block group 23.

The API gateway 30 includes an information storage 31, an access control unit 32, a vehicle determination unit 33, an boarding determination unit 34, and a policy update unit 35.

The information storage 31 stores an access authorization policy 311, a correspondence table 312, and user information 313. The correspondence table 312 may be stored in the RAM 2c. The access authorization policy 311 and the user information 313 may be stored in the ROM 2b. The access authorization policy 311 and the user information 313 may be stored in the non-volatile RAM 2c.

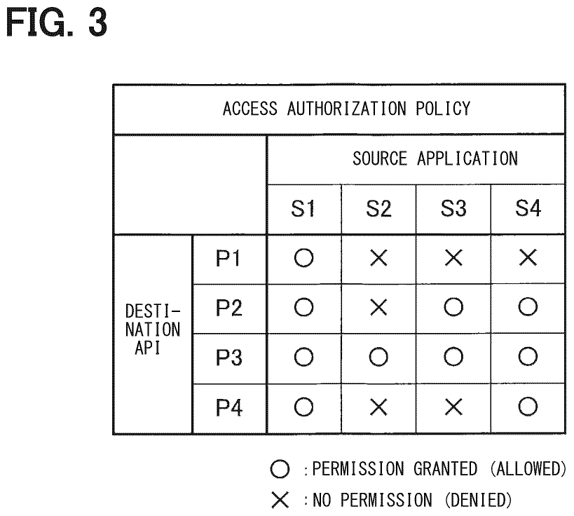

The access authorization policy 311 is a collection of information for determining whether the service application has access right to the vehicle API. The access authorization policy 311 is downloaded from the cloud server 200 using, for example, a function of a service application belonging to the data system function block group 23, and stored in the information storage 31. As shown in FIG. 3, the access authorization policy is represented by a list that defines whether the use source application identified by an application ID has access right to the use destination API identified by an API-ID.

The access authorization policy 311 may be designed considering the viewpoints of S. F. O. P, which are attributes defined as security protection assets. The S is an abbreviation for Safety, and means access restrictions on API access that affect safety. The F is an abbreviation for Financial, and means access restrictions on API access that affect corporate or personal assets. The O is an abbreviation for Operational, and means access restrictions on API access that affect the operational performance of the vehicle. The P is an abbreviation for Privacy, and means access restrictions on API access that affect privacy information.

The correspondence table 312 includes information that correlates the process ID dynamically assigned to the process that is the execution unit of the program in the operating system (hereinafter referred to as the OS) with the unique application ID possessed by the service application executed in the process. In addition, the correspondence table 312 also includes information that associates a unique API-ID of each vehicle API with the process ID of a process assigned to a service application that is an entity that executes the function of the API. The correspondence table 312 is generated by the OS when a process for each service application is generated when the system starts.

A single table may be generated by combining the access authorization policy 311 and the correspondence table 312. Specifically, a table may be generated that indicates the presence or absence of access right from the process ID of the use source application to the process ID of the use destination API by referencing the correlation between the application ID and the process ID shown in the correspondence table 312 and the correlation between the API-ID and the process ID.

The user information 313 is information that is arbitrarily set by the vehicle user. For example, the user information 313 stores contact information for the vehicle user, such as the telephone number or email address of the mobile terminal possessed by the vehicle user, in association with the user ID that identifies the vehicle user. The vehicle user may be the owner of the vehicle or a user who temporarily uses a vehicle such as a shared car.

When the access control unit 32 receives an API access request, the access control unit 32 identifies the application ID of the use source application by using the correspondence table 312 from the process ID indicated in the API access request. The access control unit 32 executes an access restriction process to determine whether or not access right exists, in accordance with the access authorization policy 311, based on the identified application ID and the API-ID of the use destination API indicated in the API access request. The details of the access restriction process will be described later.

The vehicle determination unit 33 determines the vehicle state and battery state according to a request from the policy update unit 35 and provides the determination results to the policy update unit 35. Specifically, the vehicle determination unit 33 uses an API provided by the control system function block group 22 to acquire information such as vehicle speed and shift lever position to determine whether the vehicle state corresponds to parking, stopped, or driving. For example, if the shift lever position is in parking, it is determined to be in parking; if the shift lever position is not in parking, and the absolute value of the vehicle speed is less than a predetermined value (e.g., less than 1 km/h), it is determined to be stopped; if the absolute value of the vehicle speed is equal to or greater than the predetermined value, it is determined to be driving. In addition, the vehicle determination unit 33 uses an API provided by the control system function block group 22 to acquire the battery voltage to determine whether the battery state is in a normal state or a low voltage state. The low voltage state refers to a voltage range in which the microcomputer that executes the processing to implement the functions of the API gateway 30 has a high possibility of malfunction exceeding a preset allowable value.

The boarding determination unit 34 determines the presence or absence of occupants according to a request from the policy update unit 35 and provides the determination results to the policy update unit 35. Specifically, the boarding determination unit 34 uses an API provided by the control system function block group 22 to acquire the detection results of the occupant recognition sensor 8 and determine the presence or absence of occupants.

The policy update unit 35 executes the update of the access authorization policy according to the determination results of the vehicle determination unit 33 and the boarding determination unit 34 when a situation requiring the update of the access authorization policy is detected.

### (5. Process)

### (5-1. Access Restriction Process)

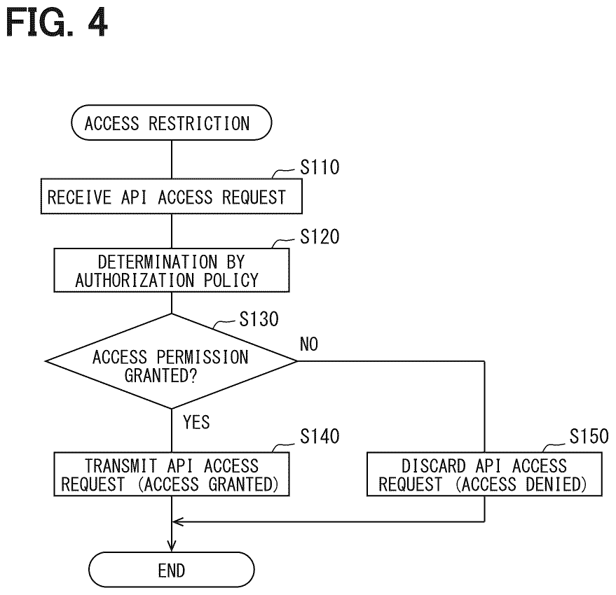

The access restriction process executed by the access control unit 32 will be described using the flowchart in FIG. 4. The access restriction process is repeatedly executed when the API gateway 30 is activated.

In S110, the access control unit 32 determines whether it has received an API access request from a service application. If the access control unit 32 has received the API access request, the process shifts to S120. If the access control unit 32 has not received the API access request, it waits by repeating the same step.

In S120, the access control unit 32 determines, based on the information indicated in the API access request, whether the use source application that has issued the API access request has the access right to the use destination API by referring to the access authorization policy 311. Specifically, the access control unit 32 first uses the correspondence table 312 to identify the application ID of the use source application from the process ID indicated in the API access request. Then, the access control unit 32 refers to the access authorization policy 311 based on the identified application ID and the API-ID of the use destination API indicated in the API access request to determine whether the use source application has the access right to the use destination API.

In the next S130, when the access control unit 32 determines that the use source application has access right to the use destination API, the process shifts to S140, and when it determines that the use source application does not have access right, the process shifts to S150.

In S140, the access control unit 32 permits access from the use source application to the use destination API, that is, transmits the API access request to the use destination API, and ends the process.

In S150, the access control unit 32 denies access from the use source application to the use destination API, that is, discards the API access request, and ends the process.

In S150, instead of simply discarding the API access request, the access control unit 32 may confirm the permission of the access with the vehicle user via the HMI device 7. If the access control unit 32 receives a permission input indicating that the access is permitted via the HMI device 7, the process shifts to S140. If the access control unit 32 receives a non-permission input indicating that the access is not permitted, it may discard the API access request.

### (5-2. Policy Update Process)

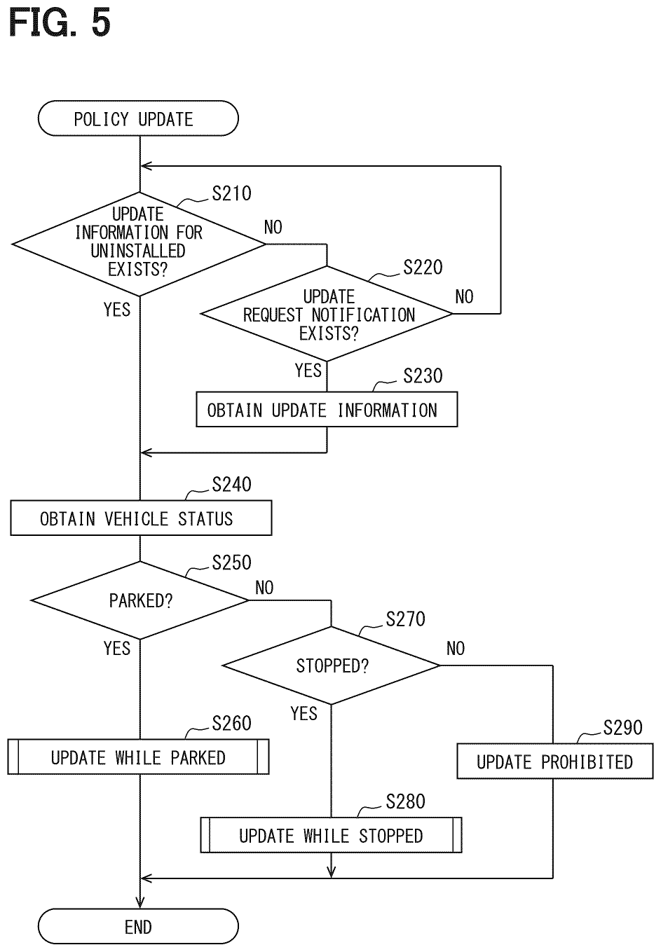

The policy update process executed by the policy update unit 35 will be described using the flowchart in FIG. 5. The policy update process is repeatedly executed when the API gateway 30 is activated.

In S210, the policy update unit 35 determines whether there is any uninstalled update information. If the policy update unit 35 determines that there is uninstalled update information, it considers it as an update necessity state where an update is required, and shifts the process to S240. If the policy update unit 35 determines that there is no uninstalled update information, it shifts the process to S220.

In S220, the policy update unit 35 determines whether there is a request for updating the access authorization policy. If there is an update request, it considers it as an update necessity state and shifts the process to S230. If there is no update request, it returns the process to S210. The update request may be a notification from the cloud server 200 indicating that a new access authorization policy to be provided to the in-vehicle system 100 has been uploaded to the cloud server 200.

In S230, the policy update unit 35 uses an API that provides a function to acquire the access authorization policy via the vehicle exterior communication device 5 to acquire the update information for the access authorization policy from the cloud server 200 and proceeds to S240.

In S240, the policy update unit 35 acquires the vehicle state via the vehicle determination unit 33.

In the next S250, the policy update unit 35 determines whether the acquired vehicle state is parking. If the policy update unit 35 determines that the vehicle is parking, it considers it a safe state where the update of the access authorization policy can be safely executed and shifts the process to S260. If the policy update unit 35 determines that the vehicle is not parking, it shifts the process to S270.

In S260, the policy update unit 35 executes the update process during parking and ends the process.

In S270, the policy update unit 35 determines whether the acquired vehicle state is stopped. If the policy update unit 35 determines that the vehicle is stopped, it considers it a safe state and shifts the process to S280. If the policy update unit 35 determines that the vehicle is not stopped, that is, if the vehicle is driving, it considers it not a safe state and shifts the process to S290.

In S280, the policy update unit 35 executes the update process during stopped and ends the process.

In S290, the policy update unit 35 prohibits the update and ends the process. When the update is prohibited, the update information is retained as uninstalled update information without being deleted.

### (5-3. Update Process During Parking)

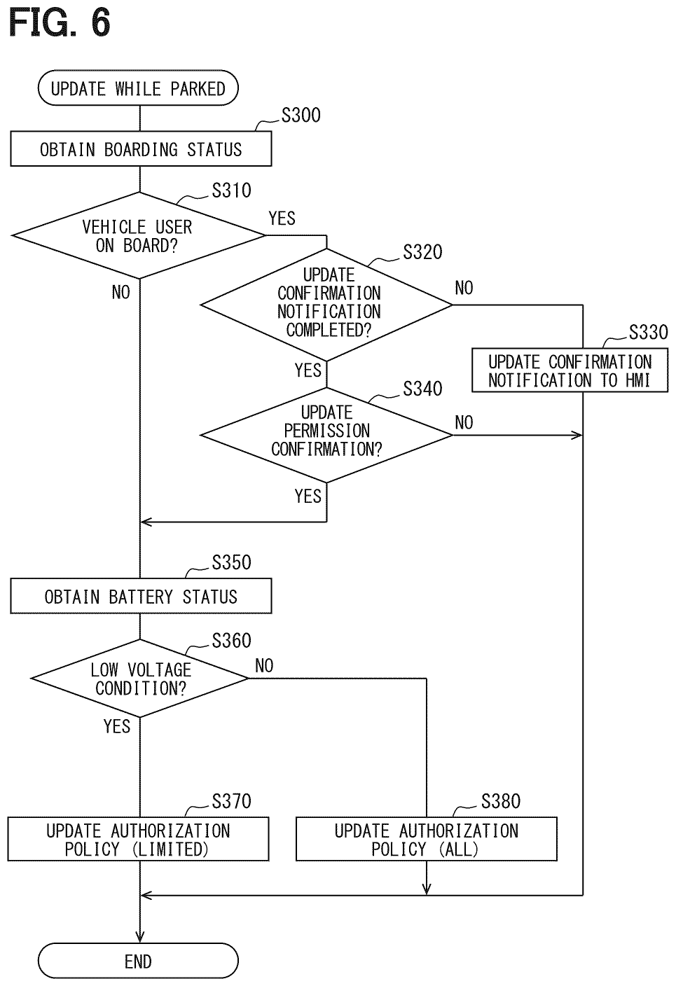

The update process during parking executed by the policy update unit 35 in S260 will be described using the flowchart in FIG. 6.

In S300, the policy update unit 35 acquires the boarding state via the boarding determination unit 34.

In the next S310, the policy update unit 35 determines from the acquired boarding state whether the vehicle user is boarding. If the vehicle user is boarding, the process shifts to S320. If the vehicle user is not boarding, the process shifts to S350.

In S320, the policy update unit 35 determines whether the update confirmation has been notified to the vehicle user. If the update confirmation has been notified, the process shifts to S340. If the update confirmation has not been notified, the process shifts to S330.

In S330, the policy update unit 35 sends an update confirmation notification using an API that provides a function to confirm the update of the access authorization policy via the HMI device 7 and ends the process.

In S340, the policy update unit 35 determines whether it has received a permission input indicating that the update of the access authorization policy is permitted via the HMI device 7. If the policy update unit 35 has received the permission input, the process shifts to S350. If the policy update unit 35 has not received the permission input, it ends the process.

In S350, the policy update unit 35 acquires the battery state via the vehicle determination unit 33.

In the next S360, the policy update unit 35 determines whether the acquired battery state is a low voltage state. If the battery state is a low voltage state, the process shifts to S370. If the battery state is not a low voltage state, the process shifts to S380.

In S370, the policy update unit 35 performs a limited update of the access authorization policy and ends the process. Specifically, the policy update unit 35 executes the installation only for the parts that have been changed from having access right to not having access right in the access authorization policy. The update information other than the updated parts is retained as uninstalled update information.

In S350, the policy update unit 35 may acquire not only the battery state but also the operation status of applications during parking. In this case, for example, in S360, if diagnostic processing or program update processing is being executed during parking, the process may shift to S370, similarly to when it is determined that the battery state is a low voltage state, and perform a limited update of the access authorization policy.

In S380, the policy update unit 35 executes the installation for all the update information and ends the process. In this case, there will be no uninstalled update information.

### (5-4. Update Process During Stopped)

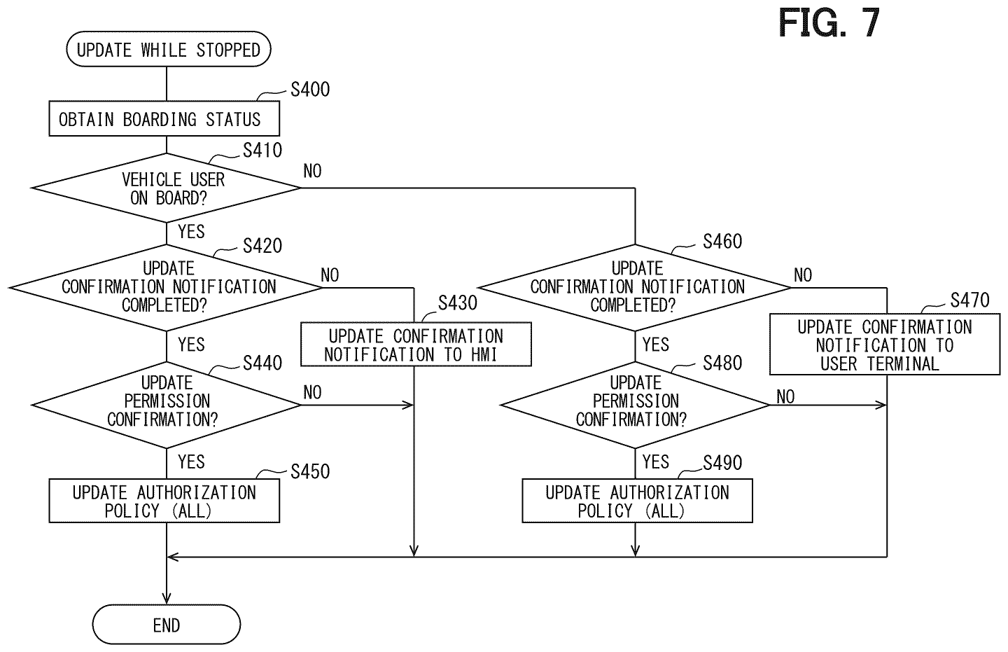

The update process during stopped executed by the policy update unit 35 in S280 will be described using the flowchart in FIG. 7.

In S400, the policy update unit 35 acquires the boarding state via the boarding determination unit 34.

In the next S410, the policy update unit 35 determines from the acquired boarding state whether the vehicle user is boarding. If the vehicle user is boarding, the process shifts to S420. If the vehicle user is not boarding, the process shifts to S460.

In S420, the policy update unit 35 determines whether the update confirmation has been notified to the vehicle user. If the update confirmation has been notified, the process shifts to S440. If the update confirmation has not been notified, the process shifts to S430.

In S430, the policy update unit 35 sends an update confirmation notification using an API that provides a function to confirm the update of the access authorization policy via the HMI device 7 and ends the process.

In S440, the policy update unit 35 determines whether it has received a permission input indicating that the update of the access authorization policy is permitted via the HMI device 7. If the policy update unit 35 has received the permission input, the process shifts to S450. If the policy update unit 35 has not received the permission input, it ends the process.

In S450, the policy update unit 35 executes the installation for all the update information and ends the process. In this case, there will be no uninstalled update information.

In S460, the policy update unit 35 determines whether the update confirmation has been notified to the vehicle user. If the update confirmation has been notified, the process shifts to S480. If the update confirmation has not been notified, the process shifts to S470.

In S470, the policy update unit 35 sends an update confirmation notification using an API that provides a function to confirm the update of the access authorization policy via the user terminal 300 through the vehicle exterior communication device 5 and ends the process.

In S480, the policy update unit 35 determines whether the policy update unit 35 has received a permission notification indicating that the update of the access authorization policy is permitted from the user terminal 300 via the vehicle exterior communication device 5. If the policy update unit 35 determines that the policy update unit 35 has received the permission notification, the process shifts to S490. If the policy update unit 35 determines that the policy update unit 35 has not received the permission notification, it ends the process.

In S490, the policy update unit 35 executes the installation for all the update information and ends the process. In this case, there will be no uninstalled update information.

In other words, in the update process during stopped, if the vehicle user is boarding, the update confirmation is checked via the HMI device 7. If the vehicle user is not boarding, the update confirmation is checked via the pre-registered user terminal 300. The update of the access authorization policy (i.e., installation of the update information) is executed only when the update permission confirmation is obtained.

### (6. Correspondence of Terms)

The service system function block group 21, the control system function block group 22, and the data system function block group 23 in the present embodiment correspond to the plurality of function blocks in the present disclosure. The API gateway 30 corresponds to the coordination control unit in the present disclosure. S210 to S220 correspond to the necessity determination unit in the present disclosure. S240, S250, and S270 correspond to the state determination unit in the present disclosure. S260 and S280 correspond to the update execution unit in the present disclosure. S320 to S330, S420 to S430, and S460 to S470 correspond to the permission confirmation unit in the present disclosure. S340, S440, and S480 correspond to the operation permission unit in the present disclosure. S300 to S310 and S400 to S410 correspond to the occupant determination unit in the present disclosure. S430 corresponds to the first confirmation unit in the present disclosure. S470 corresponds to the second confirmation unit in the present disclosure. S350 to S360 correspond to the battery state monitoring unit in the present disclosure. S370 corresponds to the limited update unit in the present disclosure.

### (7. Effects)

According to the above-described embodiment, the following effects are achieved.

(a) When update information for the access authorization policy is prepared on the cloud server 200 (i.e., Out-Car) side, the in-vehicle system 100 permits the update of the access authorization policy when the vehicle state is parking or stopped. Therefore, even if the content of vehicle control changes due to the switch of the access authorization policy, the change does not occur while the vehicle is moving, ensuring safety.

(b) In the case of stopped, the update is executed after confirming the permission of the update with the vehicle user. In other words, when the vehicle is stopped, such as waiting at a traffic signal, the vehicle user is asked whether the situation is suitable for the update, ensuring that the update of the access authorization policy is executed in a safer situation.

(c) In the case of stopped, when confirming with the vehicle user, if the vehicle user is boarding, the HMI device 7 is used, and if the vehicle user is not boarding, the pre-registered user terminal 300 is used. Therefore, the intention of the vehicle user can be confirmed by an appropriate means according to the boarding status of the vehicle user.

(d) In the case of parking, if the vehicle user is boarding, there is a possibility that the vehicle may start moving, so confirmation with the vehicle user is performed similarly to the case of stopped. If the vehicle user is not boarding, there is a low possibility that the vehicle will start moving, so the update of the access authorization policy is executed without confirming with the vehicle user. In this way, confirmation with the vehicle user is performed only in situations where confirmation is necessary, preventing unnecessary confirmation from bothering the vehicle user.

(e) In the case of parking, since the battery is not automatically charged, if the battery state is in a low voltage state, only the update information that acts on the safe side is used for the update of the authorization policy, instead of using all the update information. After the vehicle state changes from parking and the battery can be charged, the remaining update information is used for the update of the authorization policy. Therefore, the power consumption due to the update can be minimized, and malfunctions due to voltage drops (e.g., bit errors in the update information) during the update can be prevented.

### (8. Other Embodiments)

Although the embodiment of the present disclosure has been described above, the present disclosure is not limited to the above-described embodiment and can be implemented in various modifications.

(a) In the above embodiment, the update request is generated when the update information for the access authorization policy is prepared on the cloud server 200. However, the trigger for generating the update request is not limited to when the update information is prepared. For example, an update request for the access authorization policy may be generated when an abnormality is detected. In this case, an access authorization policy for abnormal situations may be prepared in advance in the information storage 31, and when an update request due to an abnormality is generated, the access authorization policy may be switched from an access authorization policy for a normal time to an access authorization policy for an abnormal time.

(b) In the above embodiment, when confirming with the vehicle user, the HMI device 7 is used if the vehicle user is boarding, but the user terminal 300 may be used similarly to when the vehicle user is not boarding.

(c) In the above embodiment, when the vehicle state is parking, confirmation with the vehicle user is performed only when the vehicle user is boarding. However, confirmation with the vehicle user may always be performed regardless of whether the vehicle user is boarding or not.

(d) In the above embodiment, when an update request notification is received from the cloud server 200, the update information for the access authorization policy is acquired from the cloud server 200. For example, the update information may be automatically downloaded from the cloud server 200 to the in-vehicle system 100, and when the download of the update information is confirmed, an update request notification may be generated internally in the in-vehicle system 100. In this case, the process in S230 in FIG. 5 may be omitted.

(e) In the above embodiment, the update of the access authorization policy according to the vehicle state and the like is applied to all APIs. However, it may be applied only to the access authorization policy related to the APIs provided by the control system function block group 22, which involves the operation of sensors and actuators. In this case, the access authorization policy related to the APIs provided by the data system function block group 23, which is used for data acquisition and the like, may be updated regardless of the vehicle state if there is uninstalled update information.

(f) The in-vehicle devices 2 to 5 and their methods described in the present disclosure may be implemented by a dedicated computer provided by constituting a processor and a memory programmed to execute one or more functions embodied by a computer program. Alternatively, the in-vehicle devices 2 to 5 and their methods described in the present disclosure may be implemented by a dedicated computer provided by constituting a processor with one or more dedicated hardware logic circuits. Alternatively, the in-vehicle devices 2 to 5 and their methods described in the present disclosure may be implemented by one or more dedicated computers configured by combinations of processors and memories programmed to perform one or more functions and processors configured by one or more hardware logic circuits. The computer program may be stored in a computer-readable non-transitory tangible storage medium as instructions to be executed by a computer. The technique for implementing the functions of each unit included in the in-vehicle devices 2 to 5 does not necessarily need to include software, and all the functions may be implemented using one or a plurality of hardware circuits.

(g) A plurality of functions of one element in the above embodiment may be implemented by a plurality of elements, or one function of one element may be implemented by a plurality of elements. In addition, multiple functions of multiple components may be realized by one component, or a single function realized by multiple components may be realized by one component. Part of the configuration of the above embodiment may be omitted. At least a part of the configuration in one embodiment may be added to or substituted for the configuration of another embodiment.

(h) In addition to the in-vehicle system 100 described above, the present disclosure can also be implemented in various forms, such as a system including the in-vehicle system 100 as a component, a program for causing a computer to function as the in-vehicle system 100, a non-transitory tangible storage medium such as a semiconductor memory in which this program is stored, and an access control method.

What is claimed is:

1. An in-vehicle system comprising:
a plurality of function blocks, each mounted on one of a plurality of electronic control units connected to an in-vehicle network, or on an external device remotely connected to the in-vehicle network, each configured to execute a predetermined process; and
a coordination control unit configured to implement coordination between the plurality of function blocks;
wherein
the coordination control unit includes:
an access control unit configured to, upon receiving an access request from a use source block, which is one of the plurality of function blocks, to a use destination block, which is another of the plurality of function blocks, determine whether the use source block has access right to the use destination block using an access authorization policy that defines access rights between the function blocks, and to transmit the access request to the use destination block when it is determined that the access right is present;
a necessity determination unit configured to determine whether to be in an update necessity state where there is a need to implement an update to the access authorization policy;
a state determination unit configured to determine whether a state of the vehicle equipped with the in-vehicle network is in a safe state where the update to the access authorization policy is safely implemented; and
an update execution unit configured to implement the update to the access authorization policy when the necessity determination unit determines to be in the update necessity state and the state determination unit determines that the vehicle is in the safe state.

2. The in-vehicle system according to claim 1, wherein
the update execution unit further includes:
a permission confirmation unit configured to confirm whether there is permission from a vehicle user to implement the update to the access authorization policy; and
an operation permission unit configured to permit the operation of the update execution unit when the permission confirmation unit confirms the permission from the vehicle user.

3. The in-vehicle system according to claim 2, wherein
the permission confirmation unit is configured to confirm whether there is permission from the vehicle user when the necessity determination unit determines to be in the update necessity state and the state determination unit determines to be the safe state.

4. The in-vehicle system according to claim 2, wherein
the update execution unit further includes
an occupant determination unit configured to determine presence or absence of an occupant in the vehicle, and
the permission confirmation unit includes:
a first confirmation unit configured to confirm the permission from the vehicle user via an HMI device provided in the vehicle when the occupant determination unit determines that there is an occupant; and
a second confirmation unit configured to confirm the permission from the vehicle user via a pre-registered user terminal when the occupant determination unit determines that there is no occupant.

5. The in-vehicle system according to claim 1, wherein
the update execution unit further includes:
a battery state monitoring unit configured to monitor a state of a battery mounted in the vehicle; and
a limited update unit configured to partially implement the update to the access authorization policy when the battery state is a low voltage state where an operation of the update execution unit may become unstable.

6. The in-vehicle system according to claim 1, wherein
the safe state is a state where the vehicle is in parking or stopped.

7. The in-vehicle system according to claim 1, wherein
the necessity determination unit determines to be in the update necessity state when there is update information for the access authorization policy.

8. The in-vehicle system according to claim 1, wherein
the necessity determination unit determines to be in the update necessity state when an abnormality of the vehicle is detected.

9. An electronic control device mounted on a vehicle, comprising:
an access control unit configured to, upon receiving an access request from a use source block, which is one of a plurality of function blocks each configured to execute a predetermined process, to a use destination block, which is another of the plurality of function blocks, determine whether the use source block has access right to the use destination block using an access authorization policy that defines access rights between the function blocks, and to transmit the access request to the use destination block when it is determined that the access right is present;
a necessity determination unit configured to determine whether to be in an update necessity state where there is a need to implement an update to the access authorization policy;
a state determination unit configured to determine whether a state of the vehicle is in a safe state where the update to the access authorization policy can be safely implemented; and
an update execution unit configured to implement the update to the access authorization policy when the necessity determination unit determines to be in the update necessity state and the state determination unit determines to be in the safe state.

10. The electronic control device according to claim 9, wherein
the necessity determination unit is configured to determine to be in the update necessity state when there is a first situation where update information for the access authorization policy exists, and when there is a second situation where an abnormality of the vehicle is detected; and
the update execution unit is configured to, in the first situation, update a normal-time access authorization policy using the update information acquired from an external device remotely connected to an in-vehicle network to which the electronic control device is connected, and in the second situation, switch to and use an abnormal-time access authorization policy prepared separately from the normal-time access authorization policy.

11. An access authorization policy update method implemented by an electronic control device mounted in a vehicle, for updating an access authorization policy that defines access rights between a plurality of function blocks each configured to execute a predetermined process, the method comprising:
determining whether to be in an update necessity state where there is a need to implement an update to the access authorization policy;
determining whether a state of the vehicle is in a safe state where the update to the access authorization policy can be safely implemented; and
implementing the update to the access authorization policy when it is determined to be in the update necessity state and it is determined to be in the safe state.

12. A non-transitory computer readable storage medium storing a program for causing a computer mounted in a vehicle to implement:
a function to determine whether to be in an update necessity state where there is a need to implement an update to an access authorization policy regarding an access authorization policy that defines access rights between a plurality of function blocks each configured to execute a predetermined process;
a function to determine whether a state of the vehicle is in a safe state where the update to the access authorization policy can be safely implemented; and
a function to implement the update to the access authorization policy when it is determined to be in the update necessity state and it is determined to be in the safe state.
